(19) United States
(12) Patent Application Publication
(10) Pub. No.: US 2003/0078843 A1
(43) Pub. Date: Apr. 24, 2003

(54) Store information processor, store information processing method and store information processing system

(75) Inventor: Nao Sone, Machida (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/099,941

(22) Filed: Mar. 19, 2002

(30) Foreign Application Priority Data
Oct. 19, 2001 (JP) 2001-321279

(51) Int. Cl. G06F 17/60

(52) U.S. Cl. 705/16

(57) ABSTRACT

A store information processor, method, and system for purchasing items, such as expendable products and supplies, which are purchased periodically, before a customer has completely used the current stock of such items. The purchase frequency of classes of items designated by the customer is calculated using a purchase record of the customer, and the estimated next purchase date is provided to the customer. The customer may place advance orders of items to be purchased.

### CROSS-REFERENCE TO RELATED APPLICATION(S)

This application is based on, and claims priority to, Japanese application number 2001-321279, filed Oct. 19, 2001, in Japan, and which is incorporated herein by reference.

### BACKGROUND OF THE INVENTION

1. Field of the Invention

The present invention relates to Internet shopping and, in particular, to a point of sale (POS) system including a server for customer transaction processing and customer information management, and a POS terminal.

2. Description of the Related Art

The Official Gazette of the Japanese Published Unexamined Patent Application 2001-175761 discloses a method for providing information and services to customers using accumulated customer information. In this method, a degree of item or product interest is determined for a customer based on the customer's accumulated purchase record and purchase frequency of an item, access record, and frequency of accessing information and advertisements about an item, or reactions to notification by, for example, an e-mail message concerning a product or various services. Also, events and prizes and various privileges such as service points, discount coupons, etc. are provided to each customer, in addition to various information and advertisements, depending on the results of the determination of product interest.

However, this method is entirely aimed at avoiding the generation of a large volume of unnecessary information not related to a customer's purchasing requirements by selecting information and services to send to the customer that depend on the interest of the customer. Also, such information is not always closely tied to items purchased by a customer in the past.

### SUMMARY OF THE INVENTION

An object of the present invention is to provide an apparatus, a system, and a method for providing item or product purchase information to a customer and allowing a customer to advance order items based on the received information, by calculating a customer's purchase frequency and estimating the expected next purchase date of items such as expendable supplies, which must be purchased periodically.

To solve the problems described above, in the present invention, purchase transaction information for a customer is received at a terminal connected to a communication network for management purposes. A purchase record is generated from the transaction information. The next purchase date of a type or class (e.g., washing detergent) of an item is estimated from the purchase frequency of the item, which is calculated using the purchase record and the transaction information. The next purchase date of the item is provided to the customer via the customer terminal as that date nears. Consequently, the customer is reminded to purchase expendable supplies, which must be purchased periodically.

Moreover, it is possible for a customer to advance order required items based on the notification of the next purchase date, and to receive future notifications that an estimated purchase date for a particular class of items is approaching. As a result, a store manager can provide various services tailored to the requirements of the customer.

These together with other aspects and advantages that will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a structural diagram of a store information processing system according to the present invention;

FIG. 2 is a block diagram of a store information processor for the system of FIG. 1;

FIG. 3 is a block diagram of a point of sale (POS) terminal for the system of FIG. 1;

FIG. 4 is a keyboard layout for the POS terminal of FIG. 3;

FIG. 5A is an item management table for the system of FIG. 1;

FIG. 5B is a department table for the system of FIG. 1;

FIG. 5C is a class table for the system of FIG. 1;

FIG. 5D is a bargain sale table for the system of FIG. 1;

FIG. 6 is a customer information management table according to a first embodiment of the present invention;

FIG. 7 is a transaction log table for the system of FIG. 1;

FIG. 8 is a purchase record table for the system of FIG. 1;

FIG. 9 is an advance order table for the system of FIG. 1;

FIG. 10 is another advance order table for the system of FIG. 1;

FIG. 11 is a flow diagram of processing in the store information processor of FIG. 2 from new customer registration to advance order processing;

FIG. 12 is a flow diagram of processing in the store information processor of FIG. 2 for sending a notification e-mail message to a customer and receiving a new transaction log;

FIG. 13 is a flow diagram of processing in a customer terminal from receipt of the notification e-mail message to advance order processing;

FIG. 14 is a flow diagram of transaction processing for a customer in the POS terminal of FIG. 3 after notification to a customer;

FIG. 15 is an example of a display screen of new customer registration for the system of FIG. 1;

FIG. 16 is an example of a display screen for designation by a customer of classes of items for which the customer is to receive an estimated purchase date notification;

FIG. 17 is an example of a notification e-mail message sent to a customer according to the first embodiment of the present invention;

FIG. 18 is an example of a customer advance order long-on display screen for the system of FIG. 1;

FIG. 19 is an example of a display screen for a customer to advance order items to be purchased for the system of FIG. 1;

FIG. 20 is an example of a display screen of the POS terminal of FIG. 3 showing advance order information for a customer;

FIG. 21 is a customer information management table according to a second embodiment of the present invention;

FIG. 22 is an example of a notification e-mail message sent to a customer according to the second embodiment of the present invention;

FIG. 23 is an example of a display screen showing notification of purchase information to a customer on the POS display screen of the POS terminal of FIG. 3;

FIG. 24 is an example of a display screen of the POS terminal of FIG. 3, showing advance order information of a customer; and

FIG. 25 is an example of a display screen showing advance order information for an Internet shopping system according to the present invention.

### DETAILED DESCRIPTION OF THE PREFERRED EMBODIMENTS

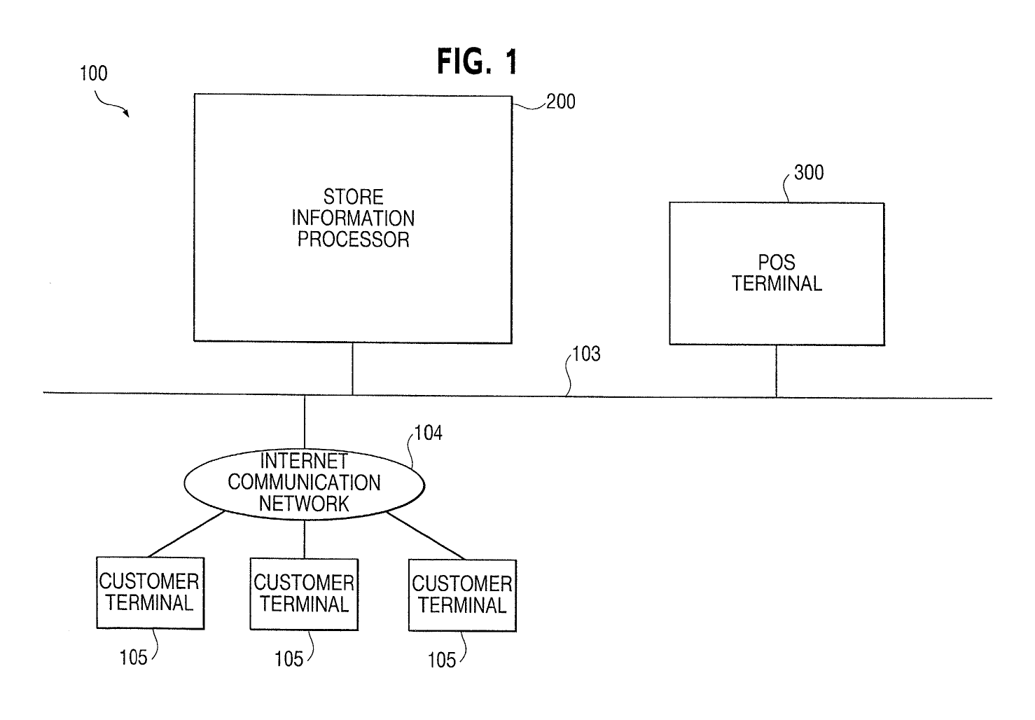

FIG. 1 is a structural diagram showing a store information processing system 100 according to a first embodiment of the present invention. In FIG. 1, the store information processing system 100 includes a store information processor 200 connected to a communication network 103, a POS terminal 300, an Internet communication network 104, and customer terminals 105 (three shown in FIG. 1) connected to the store information processor 200 via the Internet communication network 104.

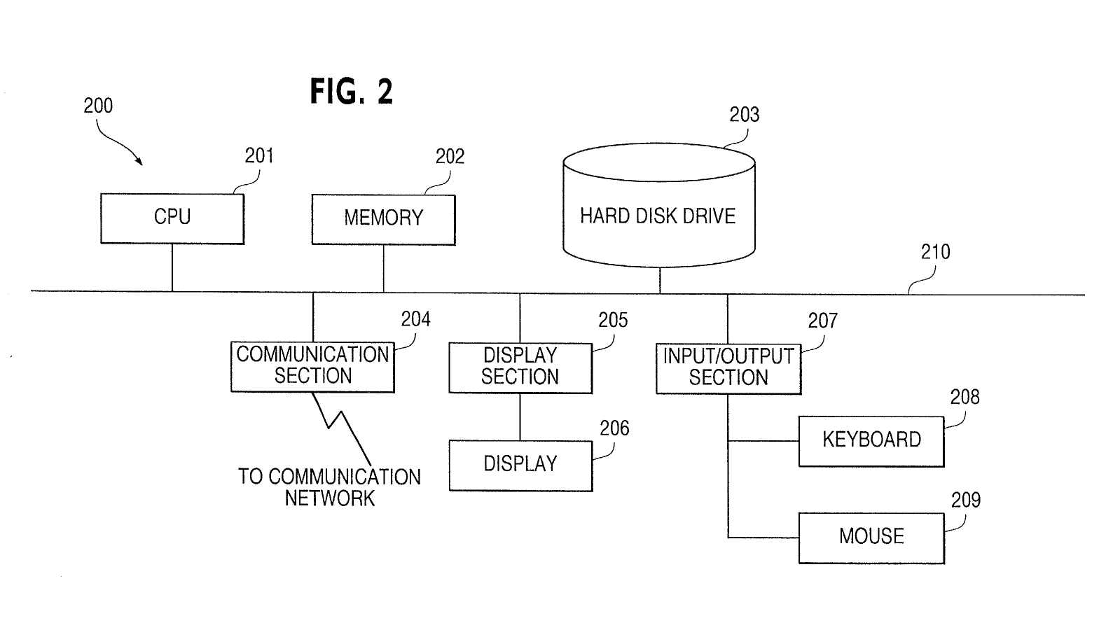

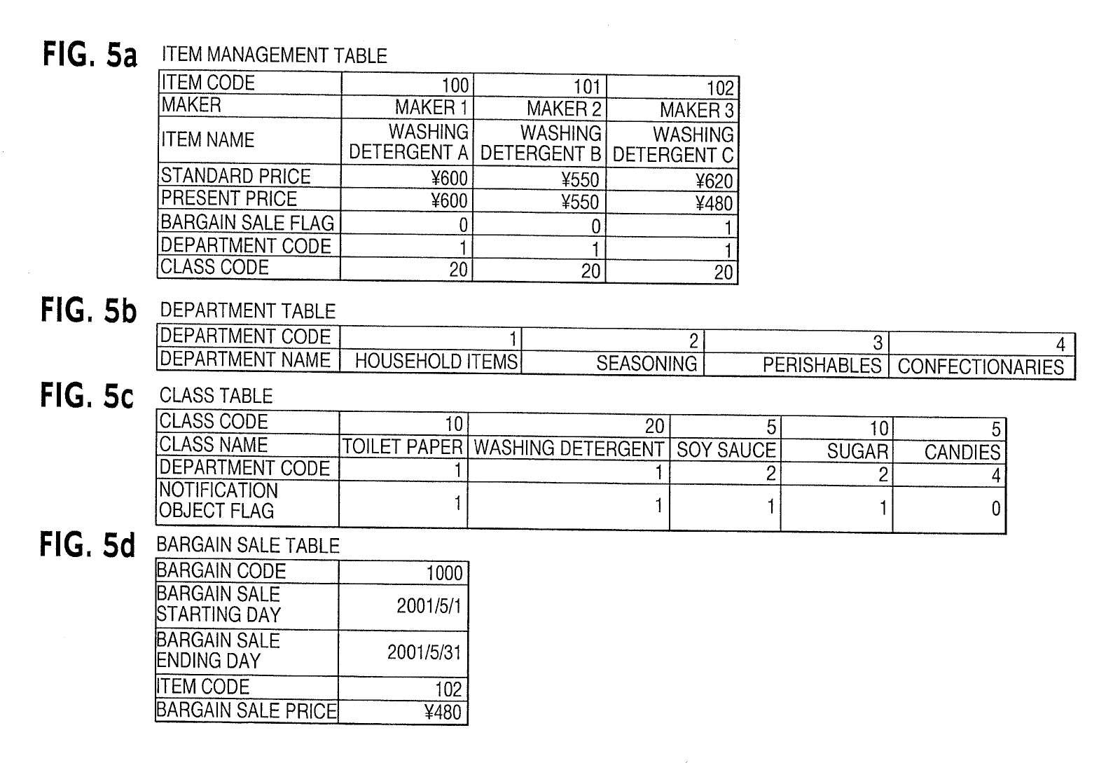

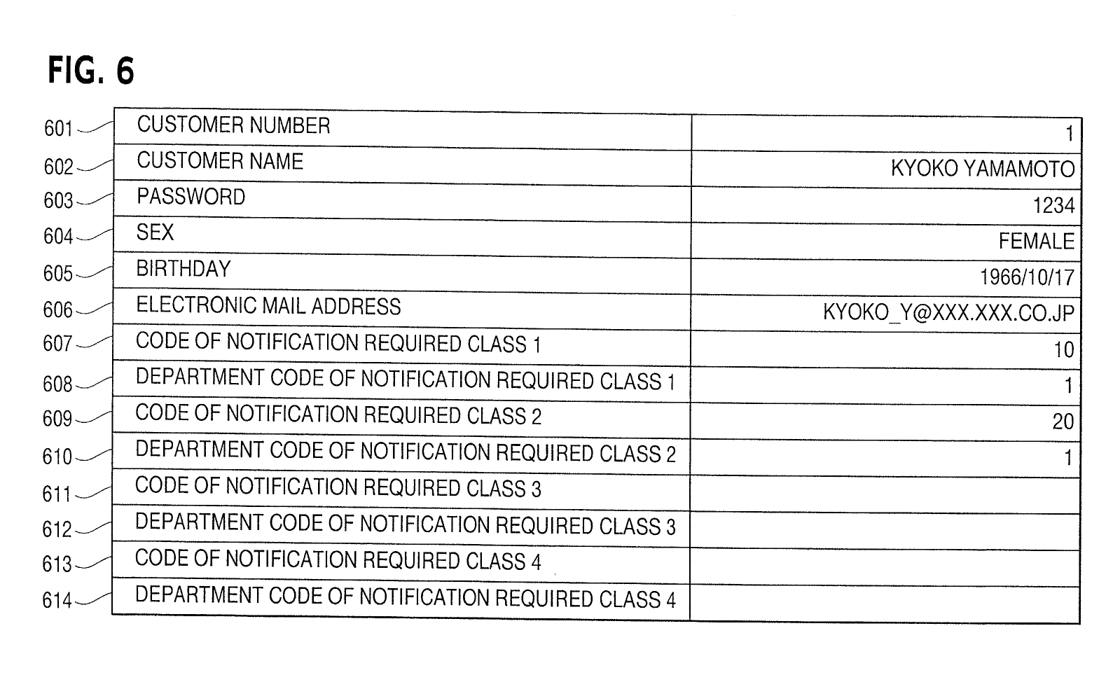

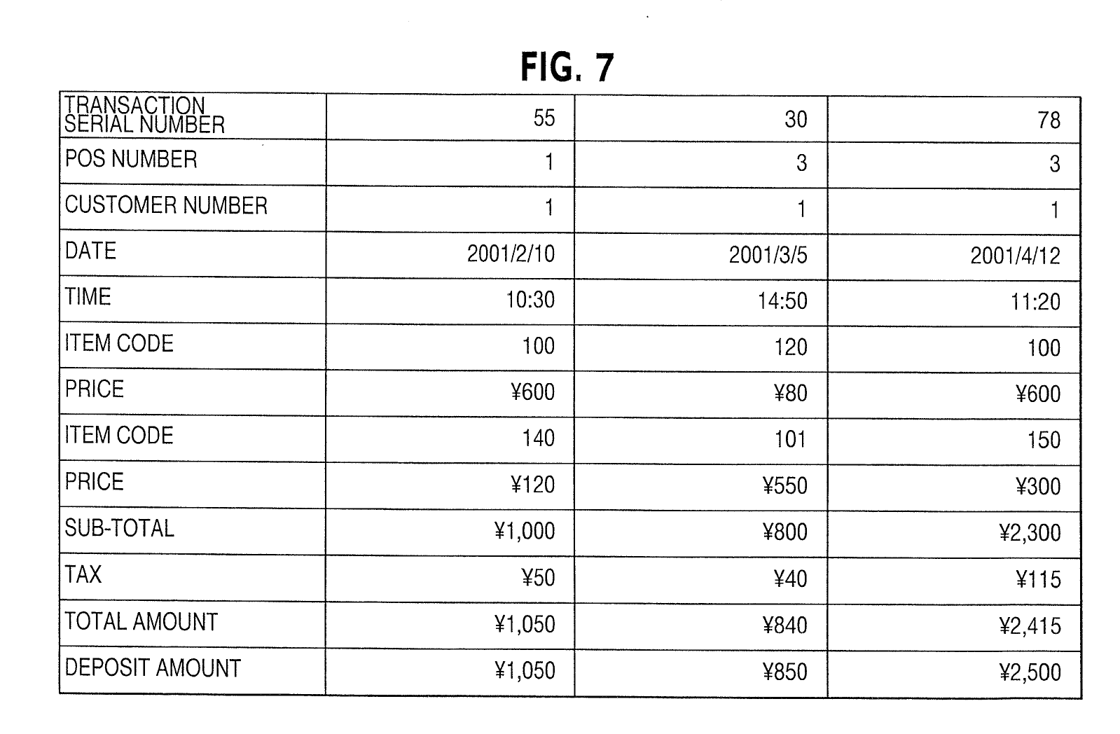

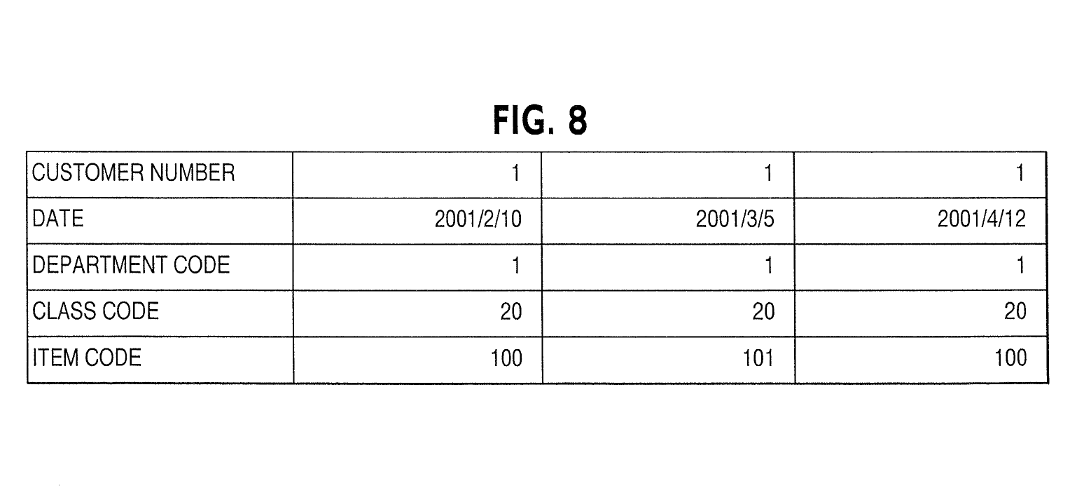

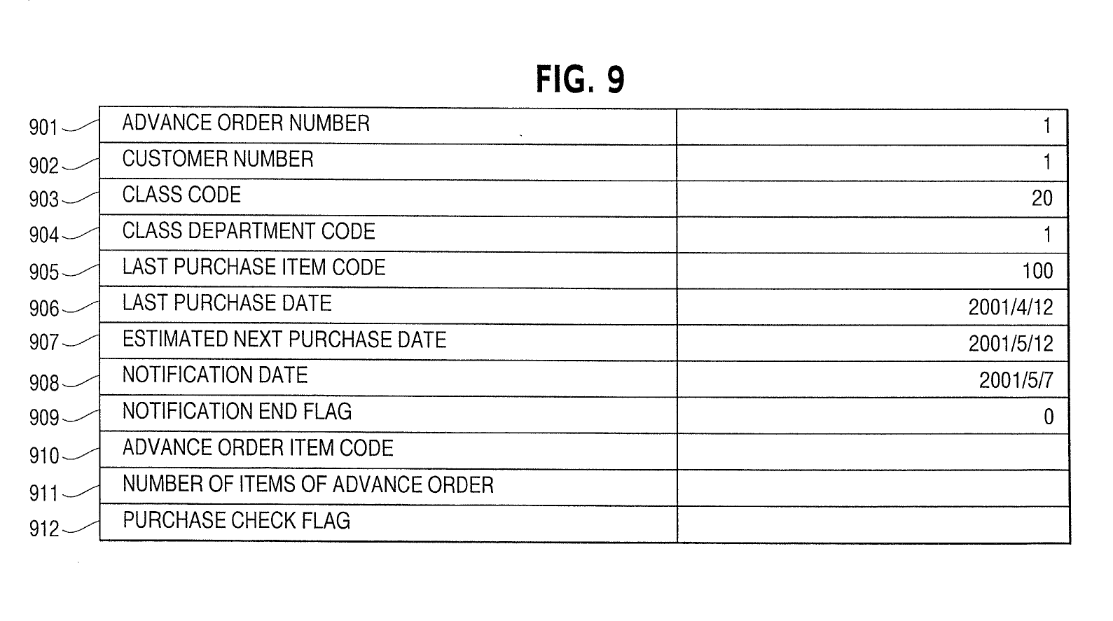

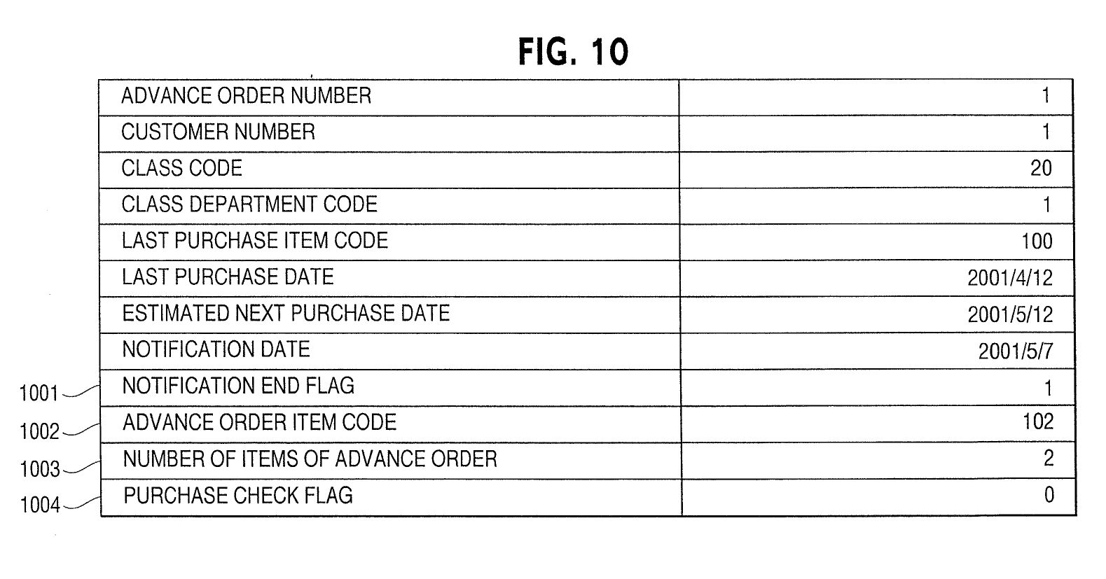

FIG. 2 is a block diagram showing a structure of the store information processor 200. The store information processor 200 includes a CPU 201, a memory 202, a hard disk 203, a communication section 204 for communication with the communication network 104, a display section 205, a display 206, an input/output control section 207, a keyboard 208, a mouse 209, and a bus 210 for connecting these elements. A transaction management section, a purchase record management section, an estimation section, a notification section, which are described below, are stored as programs in the hard disk drive 203. These programs are loaded into the memory 202 and are read from the CPU 201 for sequential execution. The hard disk drive 203 stores a database comprising a group of tables such as an item management table, a department table, a class table, a bargain sale management table, etc., as shown in FIGS. 5A to 5D. The hard disk drive 203 may also store, for example, a customer information management table (FIG. 6), a transaction log table (FIG. 7), a purchase record table (FIG. 8), and advance order tables (FIGS. 9 and 10).

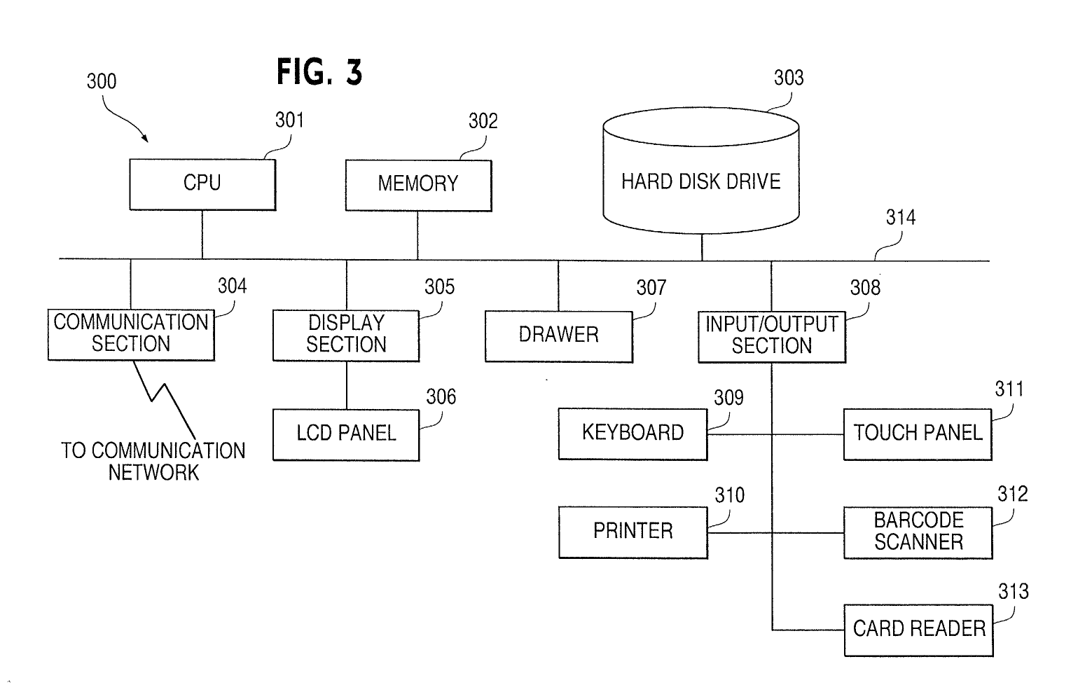

FIG. 3 is a block diagram showing a structure of the POS terminal 300. The POS terminal 300 includes a CPU 301, a memory 302, a hard disk drive 303, a communication section 304 for communicating with the communication network 104, a display section 305, an LCD panel 306, a drawer 307, a touch panel 311, a bar code scanner 312, a card reader 313, and a bus 314 for connecting these elements.

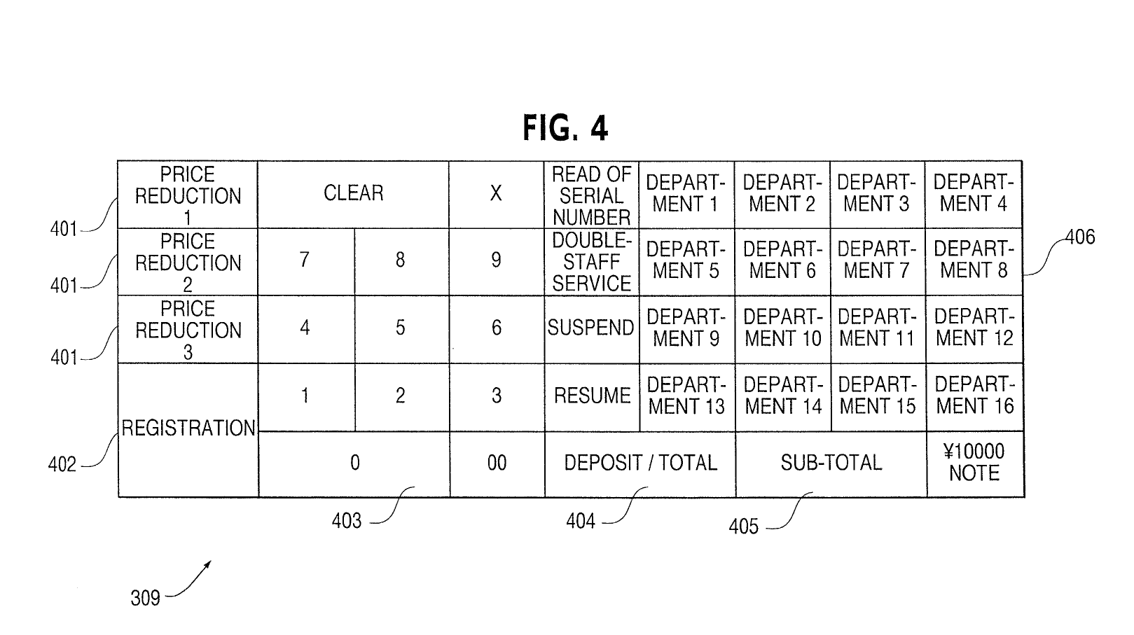

FIG. 4 shows a layout of the keyboard 309 of the POS terminal 300. The keyboard 309 includes price reduction keys 401 for manually reducing the price of an item at the time of registering the item (two price reduction keys are shown in FIG. 4), a registration key 402 that is depressed after inputting numerical data, a ten-key keypad 403 for inputting a numerical value and a plurality of input data, a deposit/total key 404 that is depressed after inputting a deposit amount from a customer, a sub-total key 405 that is depressed after registration of all transaction items is completed, and a department key section 406 for selecting predefined department codes.

FIGS. 5A to 5D show tables for item management. FIG. 5A is an item management table for storing information such as item code, item name and price, etc. FIG. 5B is a department table indicating items through classification in terms of department. FIG. 5C is a class table indicating items by breaking down classifications according to departments. FIG. 5D is a bargain sale management table for storing bargain sale information of particular items. A value of 1 is entered for the notification object flag of FIG. 5C for classes of items purchased periodically.

FIG. 6 shows an example of a customer information management table. FIG. 7 shows an example of a transaction log table having three records. FIG. 8 is an example of a purchase record table with three records that are generated based on the three records of FIG. 7.

FIG. 9 and FIG. 10 show advance order tables. FIG. 9 shows an example of an advance order table having one record before the customer is provided the purchase notification. FIG. 10 shows the same record after the customer has been notified and places an advance order.

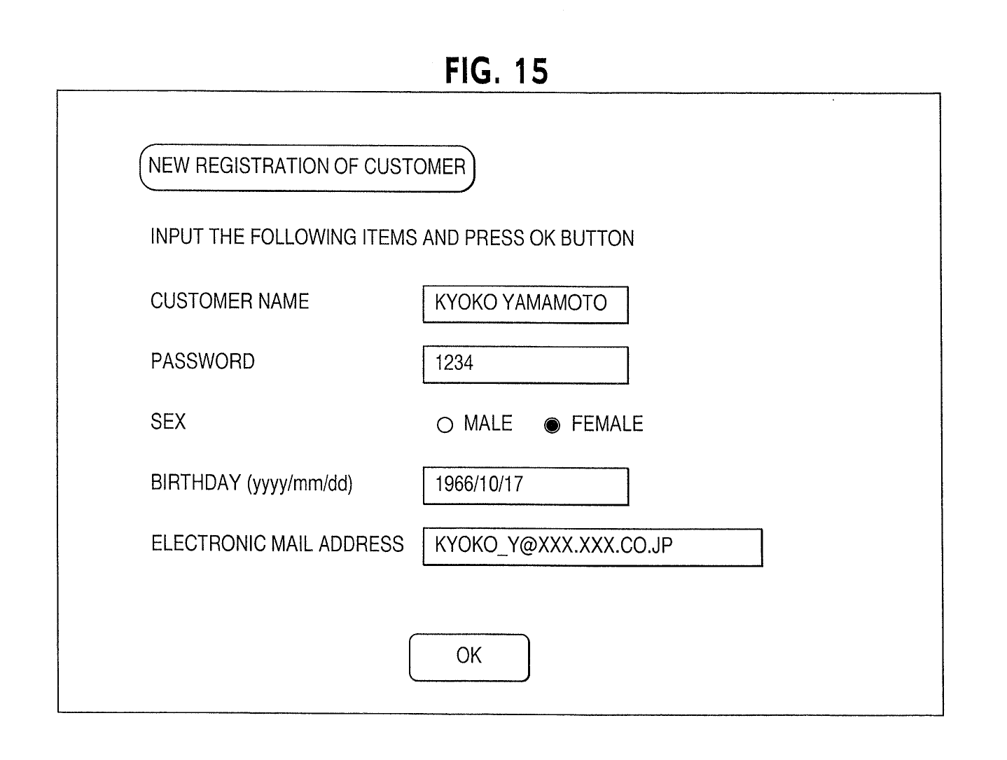

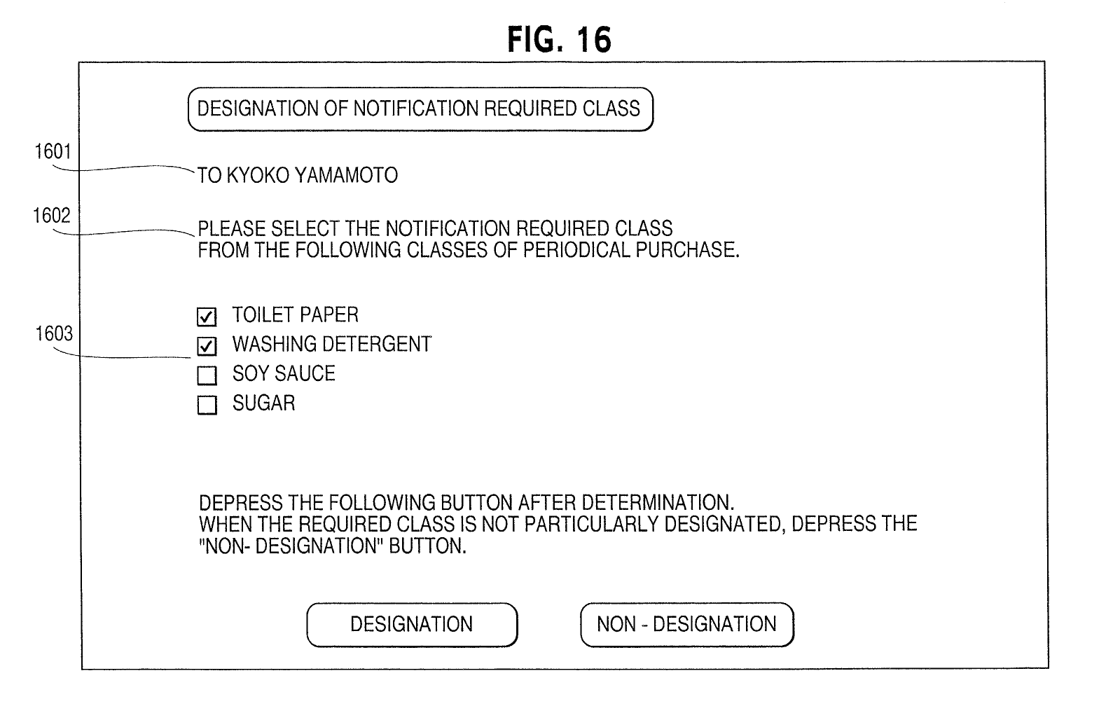

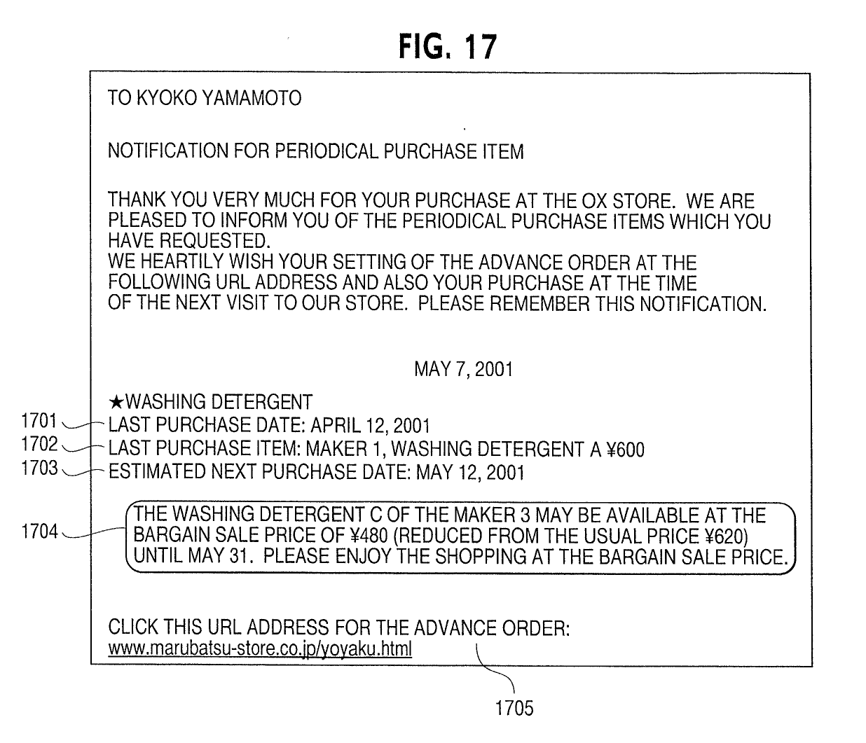

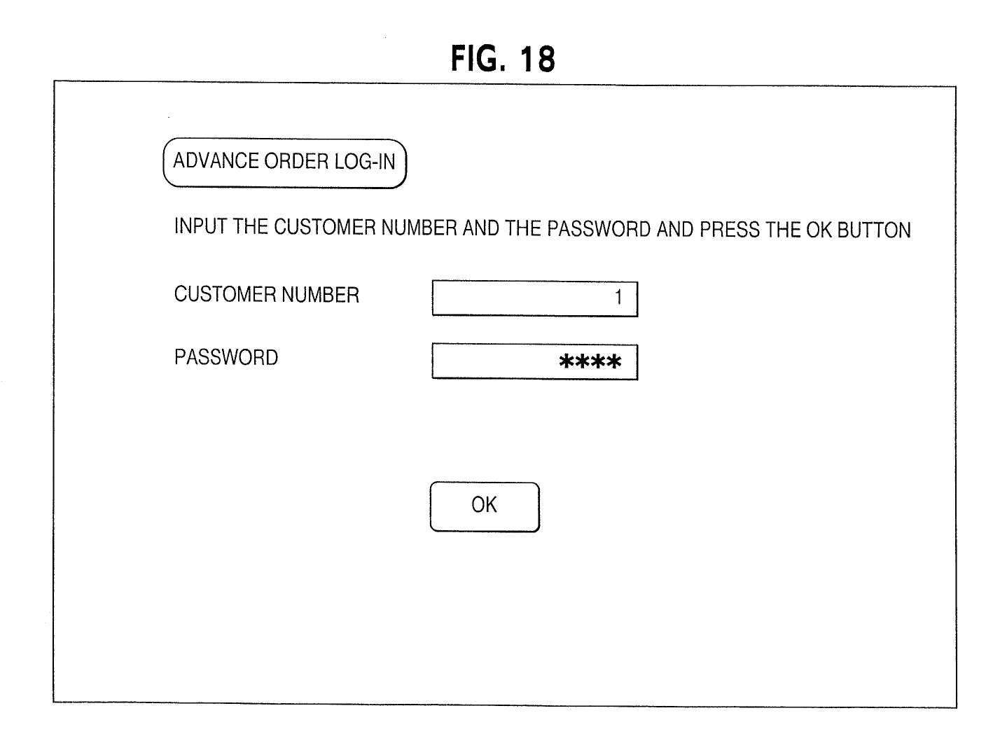

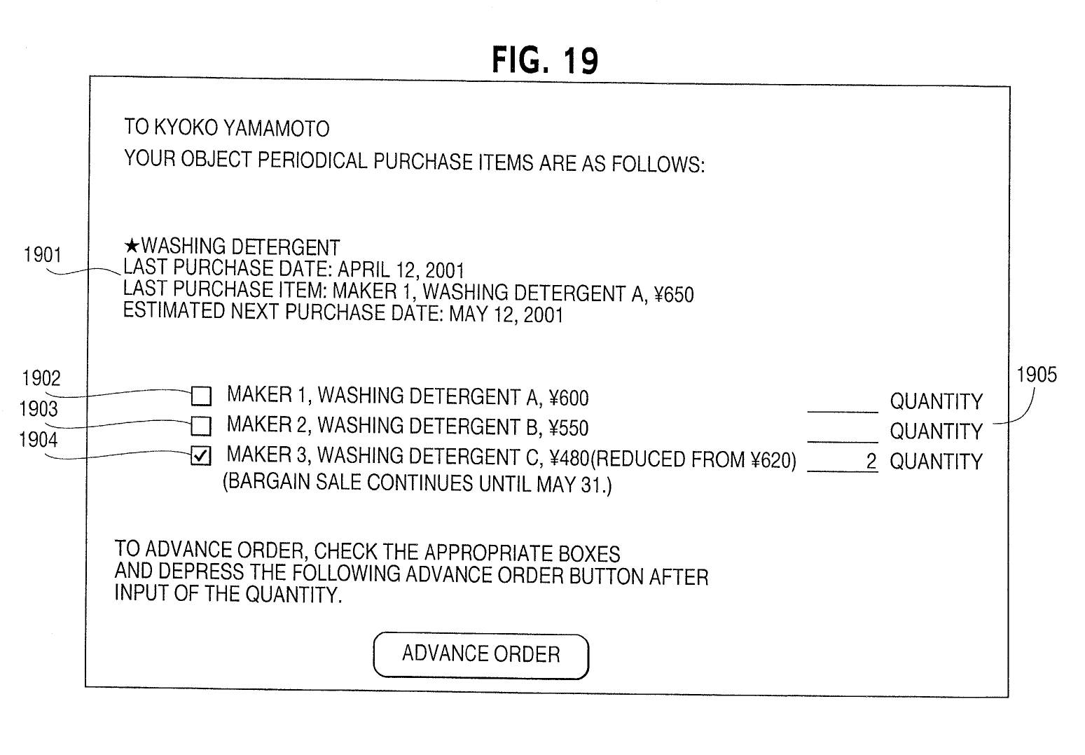

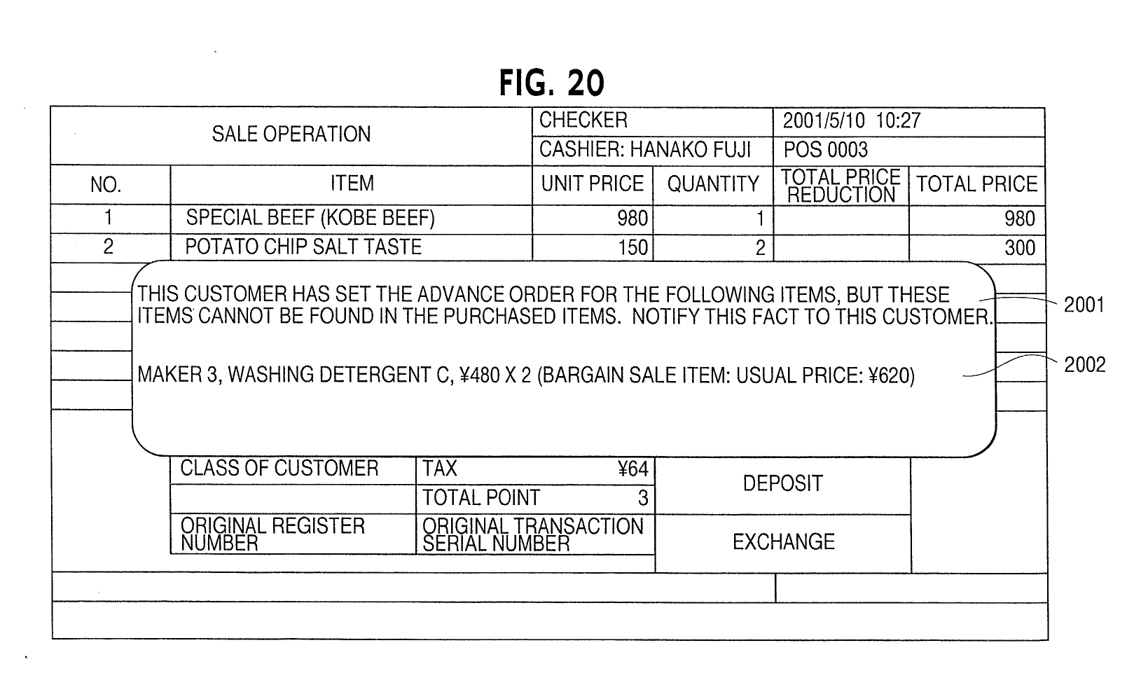

FIG. 15 shows an example of a new customer registration display screen. FIG. 16 shows an example of a display screen for the customer to select a class of items to receive a purchase notification. FIG. 17 shows an example of an e-mail message for providing the notification to the customer. FIG. 18 shows an example of a customer advance order log-in screen. FIG. 19 shows an example of a display screen on which the customer enter advance order information. FIG. 20 shows an example of an advance order item information display at the POS terminal 300.

For the first embodiment of the present invention, a description will be provided of the process flow from the customer 1 registering the customer information and designating an item class for notification, to the customer 1 receiving a notification of the estimated next purchase date, setting an advance order of the items to be purchased, and executing an actual transaction at a store.

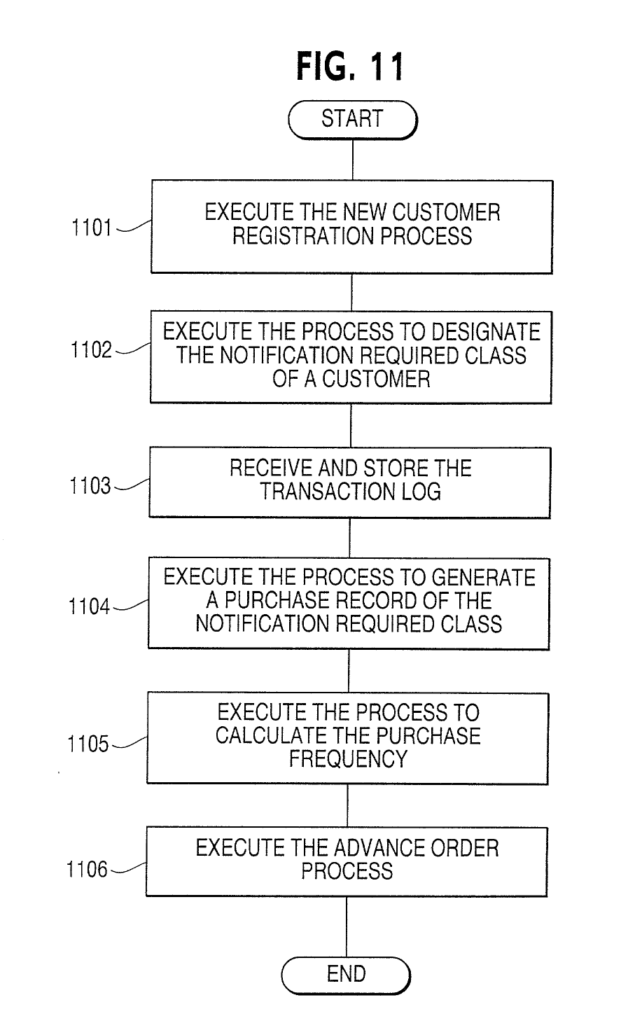

FIG. 11 is a flow diagram of processing in the store information processor 200 from new customer registration until advance order setting. At 1101, the store information processor 200 instructs a customer terminal 105 to display a new customer registration screen, as shown in FIG. 15, via the Internet network 104 of FIG. 1. When the customer depresses the OK button after inputting personal information such as customer name, password, sex, birthday, and e-mail address, the store information processor 200 receives the customer information and sets a new customer number (number “1” in the first embodiment) in the customer number field 601 for a new record in the customer information management table of FIG. 6, and also stores the received personal information, respectively, in the customer name field 602, the password field 603, the sex field 604, the birthday field 605, and the electronic mail address field 606.

The store information processor 200 also instructs the customer terminal 105 at 1102 of FIG. 11 to display the screen for designating an item class for customer notification, as shown in FIG. 16, including a customer name 1601 of the customer 1, a message 1602 prompting the customer 1 to designate an item class, and a name of the item class 1603 from a group of classes, which have a value of 1 set for the notification object flag in the class table of FIG. 5C. The customer 1 designates the item class for notification from the classes displayed, and then depresses a designation button to send the class data to the store information processor 200 via the Internet communication network 104.

In this example, the customer 1 selects toilet paper and washing detergent. The store information processor 200 stores, based on the class information received, the corresponding class code and the department code in the customer information management table, as shown in FIG. 6. For the toilet paper, a value of 10 is stored in the notification required class 1 code 607, and a value of 1 is stored in the department code of notification required class 1 field 608. For the washing detergent, a value of 20 is stored in the notification required class 2 code 609, and a value of 1 is stored for the department code of the notification required class 2 field 610.

The store information processor 200 receives at 1103 of FIG. 11 the customer 1 transaction information in the POS terminal 300, and stores this transaction information in the transaction log table shown in FIG. 7. FIG. 7 shows an example of three transactions executed by the customer 1 on Feb. 10, 2001, Mar. 5, 2001, and Apr. 12, 2001.

At 1104 of FIG. 11, the store information processor 200 generates a purchase record from the transaction log table, the customer information management table, and the item management table and stores this purchase record in the purchase record table of FIG. 8. As shown in FIG. 7, the customer 1 purchased the item having an item code of 100 in the transaction of Feb. 10, 2001. The item having the item code of 100 can be identified as washing detergent A from the item management table of FIG. 5A, and it is also determined that the department code of this item is 1 and the class code is 20. Referring to the customer information management table of FIG. 6, because the code of notification required class 2 field 609 has a value of 20 and the department code of notification required class 2 field 610 has a value of 1, the item having an item code of 100 is an item for which the customer 1 requests notification of the next expected purchase date. In the same manner, in FIG. 7, the item having the item code of 101 for the transaction on Mar. 5, 2001 and the item having the item code of 100 in the transaction of Apr. 12, 2001 belong to the same item class (washing detergent), as shown in FIG. 5A. Accordingly, the three records shown in the purchase record table of FIG. 8 can be generated.

At 1105 of FIG. 11, the store information processor 200 calculates the purchase frequency of the designated items from the records stored in the purchase record table of FIG. 7. The purchase frequency of the items having the class code 20 is estimated from the past three purchase records of the purchase record table of FIG. 7 for customer 1 by calculating an average interval between the last three purchase dates.

The advance order table is updated at 1106 of FIG. 11. As shown in FIG. 9, the advance order table stores an advance order number 901, a customer number 902, a class code 903, a class department code 904, a last purchase item code 905, a last purchase date 906, an estimated date of next purchase 907, a notification date 908, and a notification end flag 909. The number for identifying the advance order record is set as the advance order number 901. The estimated next purchase date, which is estimated from the calculated purchase frequency, is set as the estimated date of next purchase 907. The date that is five days before the estimated date of next purchase 907 is set as the notification date 908. A value of 0, indicating the customer has not been notified of the estimate next purchase date, is set as the notification end flag 909. This record of the advance order table also includes an advance order item code 910, the number of items of advance order 911, and a purchase confirmation flag 912. The last three fields do not have a value at this point, indicating that the customer has not set an advance order or purchased the items.

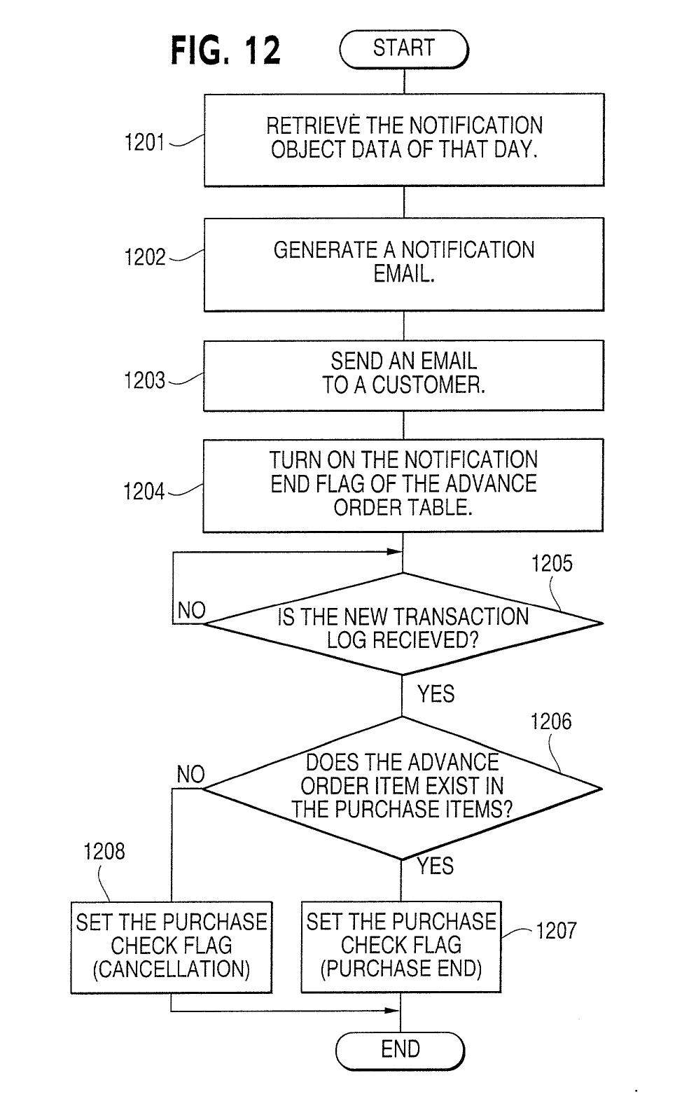

FIG. 12 is a flow diagram of processing for sending a notification e-mail message to a customer and receiving a new transaction log in the store information processor 200. At 1201, a record having a notification date the same as the current date is retrieved from the advance order table. For example, if the current date is May 7, 2001, a record having a notification date of May 7, 2001 is retrieved from the advance order table of FIG. 9. At 1202 of FIG. 12, a notification e-mail message addressed to the customer 1 is generated from the information retrieved at 1201, the item management table, and the customer management information table.

The notification e-mail message is sent at 1203 via the Internet communication network 104, to the e-mail address of the customer 1 indicated in the electronic mail address field 606 of FIG. 6. An example of the notification e-mail message sent to the customer 1 is shown in FIG. 17. The e-mail message includes the last purchase date 1701, the last purchase item 1702, the estimated next purchase date 1703, and bargain sale information 1704. In this example, the item having an item code of 102 and a class code of 20 is determined to be the bargain sale object during the period from May 1, 2001 to May 31, 2001 as shown in the bargain sale management table of FIG. 5D. At 1204 of FIG. 12, a value of 1, indicating the end of notification, is stored in the notification end flag field 1001 of the advance order table of FIG. 10 after the notification e-mail message has been sent to the customer 1.

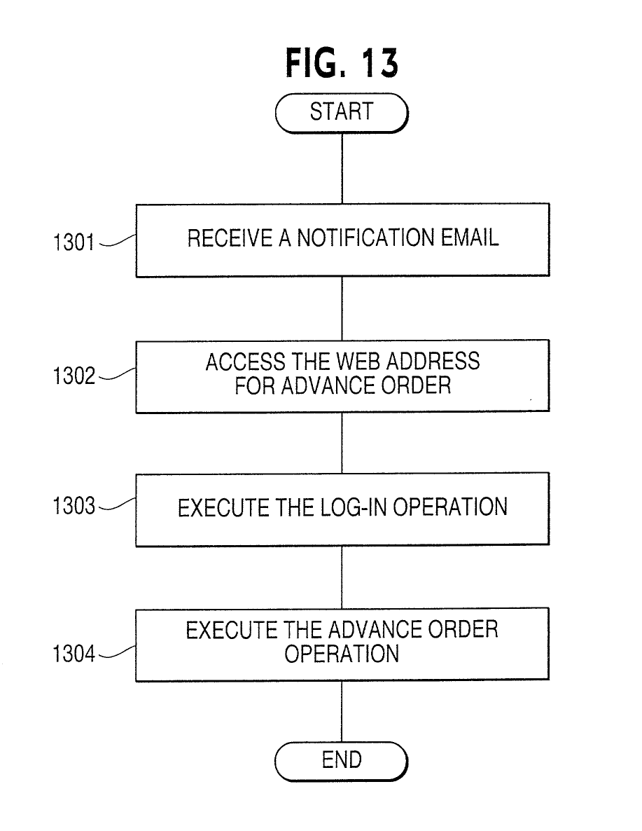

FIG. 13 is a flow diagram of processing from reception of the notification e-mail message at the customer terminal 105 to the advance order operation. When the customer 1, having received at 1301 the notification e-mail message shown in FIG. 17, selects at 1302 a web address 1705 in FIG. 17 to place an advance order, an advance order log-in screen is displayed on the customer terminal 105, as shown in FIG. 18.

At 1303 of FIG. 13, the customer 1 logs in by inputting on the screen shown in FIG. 18 the customer number, which has been stored in the customer number field 601 of FIG. 6 and the password, which has been stored in the password field 603 of FIG. 6, and then clicking the OK button.

When the customer 1 logs in, an advance order screen shown in FIG. 19 is generated at 1304 on the basis of the advance order table, the customer information management table, and the item management table. The periodical purchase item information 1901, which is similar to the information indicated in the notification e-mail message, and the item information 1902 to 1904 belonging to the washing detergent class having the class code of 20, are displayed in FIG. 19, in addition to the customer name of the customer 1. In this example, the customer 1 selects washing detergent C 1904 and a desired quantity 1905 of 2, and then clicks the advance order button. With this process, the item code of 102, indicating the washing detergent C selected by the customer 1, is stored as the advance order item code 1002 of the advance order table shown in FIG. 10, and the value of 2 is stored in the advance order number field 1003. Moreover, because the customer 1 placed an advance order for purchasing an item but has not actually purchased the item, a value of 0, indicating the non-purchasing condition, is stored in the purchase check flag 1004.

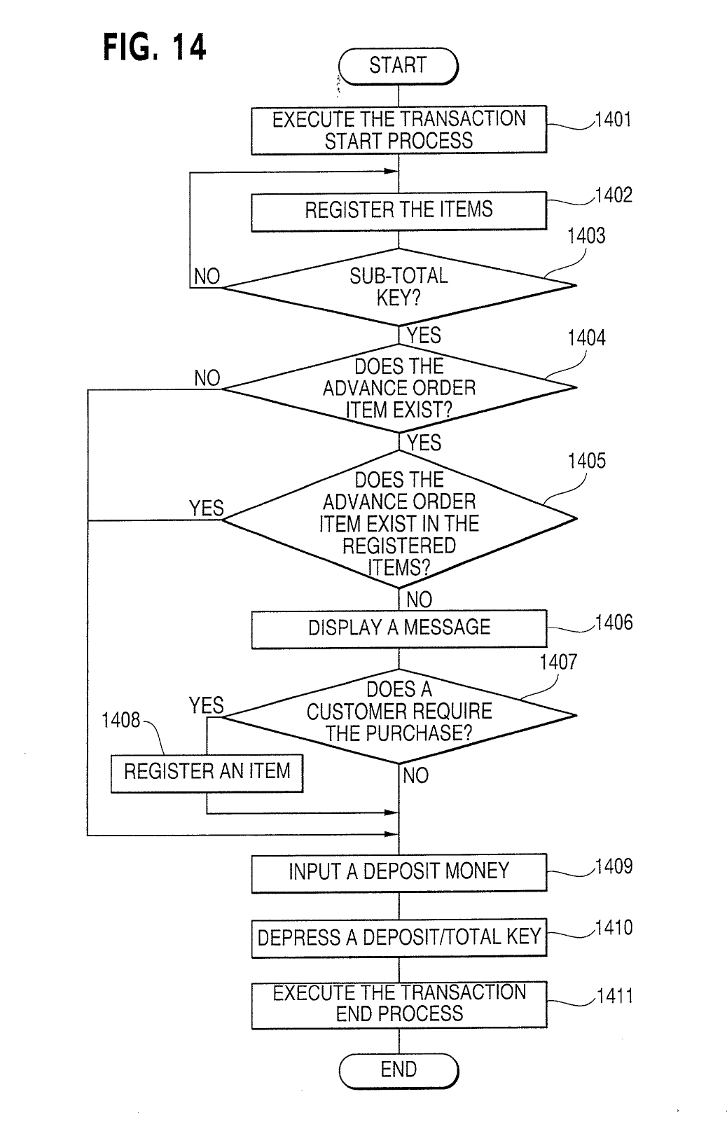

FIG. 14 is a flow diagram of processing of the latest transaction of a customer 1 at the POS terminal 300 after the customer 1 is notified. At 1401, the transaction start process is executed at the POS terminal 300. When the customer 1 presents, for example, a customer card identifying the customer to a store employee, the employee can determine, from this customer card, a value of 1, indicating the customer number of the customer 1, using a card reader 313 (FIG. 3). Information about the customer 1 can be obtained from the customer information management table of the store information processor 200 based on this customer number.

At 1402, the employee registers the item that the customer 1 wants to purchase by scanning a bar code of the item using a bar code scanner 312 (FIG. 3). When a sub-total key 405, shown in the keyboard layout of FIG. 4, is depressed at 1403, it is determined at 1404 whether the customer 1 has already placed an advance order for purchasing the item by checking the advance order table of the store information processor 200.

In this embodiment 1, because the customer 1 placed an advance order for purchase of washing detergent C at 1304 of FIG. 13 and the purchase check flag 1004 of FIG. 10 has a value of 0, indicating the end of setting the advance order, whether the washing detergent C is included in the registered items of this transaction is checked at 1405.

If the customer 1 has not yet placed an advance order for purchasing the item at 1404, or when the washing detergent C is included in the registered items of this transaction at 1405, the processes beginning with the input of deposit money at 1409 are executed. If the washing detergent C is not included in the registered items at 1405, reference is made to the advance order table and the tables of item management of the store information processor 200 1406, and the employee can explain the contents of the display to the customer 1 because an advance order end notification message 2001 and advance order item information 2002, as shown in FIG. 20, are displayed on the LCD panel 306 (FIG. 3).

When the customer 1 requests the purchase of washing detergent C at 1407, the washing detergent C is also registered at 1408. At 1409, deposit money is input using the ten-key keypad 403 of FIG. 4. The deposit/total key 404 is depressed at 1410 and the transaction end process is executed at 1411. Thereafter, the log of this transaction is sent to the store information processor 200.

Returning to FIG. 12, after sending the notification e-mail message to the customer 1 and receiving the new transaction log of the customer 1 at 1205, which is stored in the transaction log table, whether the advance order item (washing detergent C) exists in the items purchased by the customer 1 during the new transaction is checked at 1206. When the advance order item exists, the value of 1, indicating the end of purchase, is stored in the purchase check flag 1004 of the advance order table of FIG. 10 at 1207. However, if the item does not exist, the value of 2, indicating cancellation, is stored at 1208. Thus, when the customer 1 visits the store again, it is possible to determine whether the message shown in FIG. 20 should be displayed.

As explained above with respect to the first embodiment of the present invention, a customer 1 can receive a notification informing the customer 1 that the next purchase date for the item for which the customer 1 requested notification is approaching.

In a second embodiment of the present invention, a flow of processes when a customer does not designate an item to receive an estimated purchased date notification will be explained on the basis of the first embodiment, with reference to FIGS. 1-5, 7-10, 12-16, 18-20, and 21-23. In the second embodiment, the next purchase date is estimated and sent to the customer for all item classes that require periodic purchase.

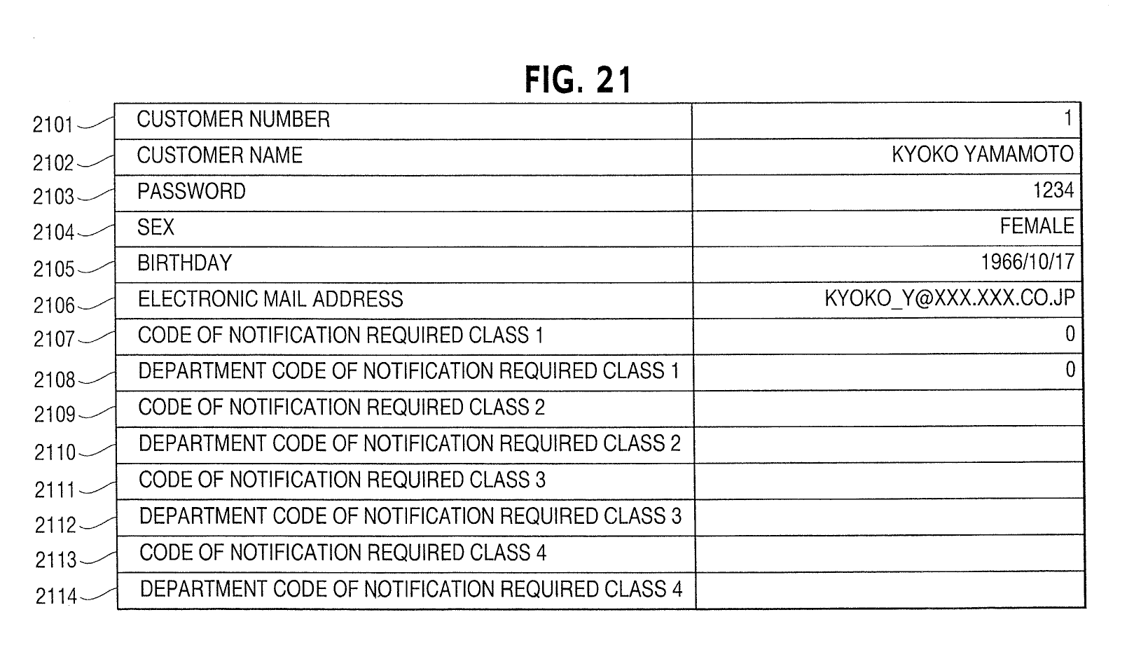

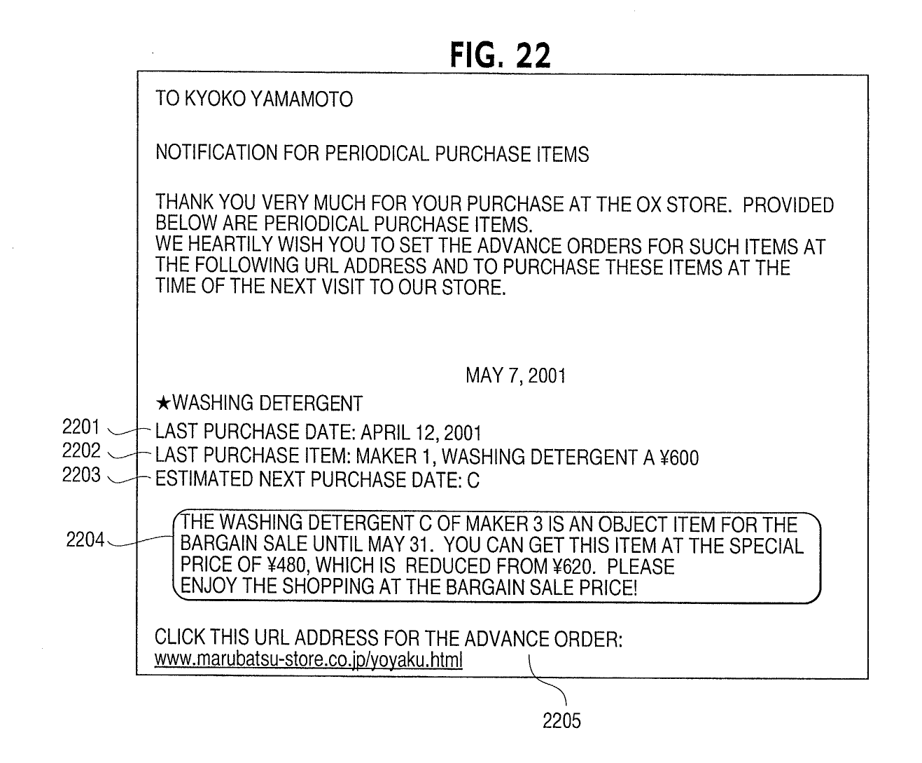

The diagrams and operations of FIGS. 1-5, 7-10,12-16, and 18-20 are the same for the second embodiment as they were for the first embodiment. For the second embodiment of the present invention, FIG. 21 shows an example of the customer information management table, and FIG. 22 shows an example of a notification e-mail message sent to the customer 1.

Referring to FIG. 11 at 1101, when the customer 1 registers and enters the customer information, the store information processor 200 receives the personal information and sets a new customer number of 1 in the customer number field 2101 for a new record in the customer information management table of FIG. 21, and also stores the received personal information in the customer name field 2102, the password field 2103, the sex field 2104, the birthday field 2105, and the electronic mail address field 2106, respectively.

At 1102 of FIG. 11, the store information processor 200 instructs the customer terminal 105 to display the screen for designating an item class for customer notification, as shown in FIG. 16. However, in the second embodiment, when the customer 1 depresses the “non-designation” button without making a particular designation of the item class for notification, the store information processor 200 is informed that a class has not been selected via the Internet communication network 104. Accordingly, the store information processor 200 stores a value of 0 for the code of notification required class 1 field 2107 and the value of 0 for the department code of the notification required class 1 field 2108, as shown in FIG. 21.

At 1103 of FIG. 11, the store information processor 200 receives the customer 1 transaction information in the POS terminal 300 and stores this information in the transaction log table, as shown in FIG. 7. FIG. 7 shows an example of three transactions executed by the customer 1 on Feb. 10, 2001, Mar. 5, 2001, and Apr. 12, 2001.

At 1104 of FIG. 11, the store information processor 200 generates a purchase record from the transaction log table, the customer information management table, and the tables for item management, and then stores this purchase record in the purchase record table of FIG. 8. In the second embodiment of the present invention, it is determined that the customer 1 has not designated a class because the value of 0 is stored in both the code of the notification required class 1 field 2107 and the department code of the notification required class 1 field 2108 of the customer information management table of FIG. 21. Next, it is determined whether item classes having a notification object flag of 1 in the class table of FIG. 5C were in the previous three transactions.

As shown in FIG. 7, the customer 1 purchased the item having an item code of 100 in the transaction of Feb. 10, 2001. The item having the item code of 100 can be identified as washing detergent A, the department code of this item can be identified as 1, and class code thereof as 20 from the item management table of FIG. 5A. The class having the class code of 20 can also be identified as a notification class object from the class table of FIG. 5C. In the same manner, it can be determined that the item having the item code of 101 for the transaction on Mar. 5, 2001 and the item having the item code of 100 for the transaction on Apr. 12, 2001 belong to the same class. Thus, the three records shown in the purchase record table of FIG. 8 can be generated.

At 1105 of FIG. 11, the store information processor 200 calculates the purchase frequency of the items from the records stored in the purchase record table of FIG. 7. The purchase frequency of the items having the class code of 20 is estimated from the past three purchase records of the purchase record table of FIG. 7 for customer 1 by calculating the average interval between the last three purchase dates. The advance order table is updated at 1106 of FIG. 11, as described above for the first embodiment of the present invention.

FIG. 12 is a flow diagram of processing for sending a notification e-mail message to a customer and for receiving a new transaction log in the store information processor 200. At 1201, a record having a notification date the same as the current date is retrieved from the advance order table. For example, if the current date is May 7, 2001, the record having the advance order number of 1 in the advance order table of FIG. 9 is retrieved. At 1202 of FIG. 12, a notification e-mail message addressed to the customer 1 is generated from the information retrieved at 1201, the item management table, and the customer management information table.

The notification e-mail message is sent at 1203 via the Internet communication network 104 to the e-mail address of the customer 1 indicated in the electronic mail address field 2106 of FIG. 21. An example of the notification e-mail message sent to the customer 1 is shown in FIG. 22. The notification e-mail message includes the last purchase date 2201, the last purchase item 2202, the estimated next purchase date 2203, and bargain sale information 2204. In this example, the item having an item code of 102 and a class code of 20 is considered as being the bargain sale object during the period from May 1, 2001 to May 31, 2001, as shown in the bargain sale management table of FIG. 5D. At 1204 of FIG. 12, a value of 1, indicating the end of notification, is stored in the notification end flag field 1001 of the advance order table of FIG. 10 after the notification e-mail message has been sent to the customer 1.

FIG. 13 is a flow diagram of processing from reception of the notification e-mail message at the customer terminal 105 to the advance order operation. When the customer 1, having received at 1301 the notification e-mail message shown in FIG. 22, selects at 1302 web address 2205 in FIG. 22 to place an advance order, an advance order log-in screen is displayed on the customer terminal 105, as shown in FIG. 18.

At 1303 of FIG. 13, the customer 1 logs in by inputting on the screen shown in FIG. 18 the value of 1 stored in the customer number field 2101 of FIG. 21 and the password stored in the password field 2103, and then clicking the OK button.

When the customer 1 logs in, an advance order screen shown in FIG. 19 is generated at 1304 on the basis of the advance order table, the customer information management table, and the item management table. The periodical purchase item information 1901, and the item information 1902 to 1904 belonging to the washing detergent class having the class code of 20, which are similar to the information indicated in the notification e-mail message, are displayed, in addition to the customer name of the customer 1. In this example, the customer 1 selects washing detergent C 1904 and a desired quantity 1905 of 2, and then clicks the advance order button. With this operation, the item code of 102, indicating the washing detergent C selected by the customer 1, is stored as the advance order item code field 1002 of the advance order table shown in FIG. 10, and the value of 2 is stored in the advance order number field 1003. Moreover, because the customer 1 placed an advance order for purchasing an item but has not actually purchased the item, a value of 0, indicating the non-purchasing condition, is stored in the purchase check flag 1004.

FIG. 14 is a flow diagram of processing of the latest transaction of the customer 1 at the POS terminal 300 after the customer 1 has been notified. The flow of processing for FIG. 14 is the same as described above for the first embodiment of the present invention.

Returning to FIG. 12, after sending the notification e-mail message to the customer 1 and receiving the new transaction log of the customer 1 at 1205, which is stored in the transaction log table, whether the advance order item (washing detergent C) exists in the items purchased by the customer 1 during the new transaction is checked at 1206. When the advance order item exists, the value of 1, indicating the end of purchase, is stored in the purchase check flag 1004 of the advance order table of FIG. 10 at 1207. However, if the advance order item does not exist, the value of 2, indicating cancellation, is stored at 1208. Thus, when the customer 1 visits the store again, it can be determined whether the message shown in FIG. 20 should be displayed.

As explained above with respect to the second embodiment of the present invention, when a customer 1 does not designate an item class for notification, the customer 1 can automatically receive a notification informing the customer 1 that the next purchase date is approaching for the items (expendable supplies) that are generally assumed to be purchased periodically, preventing the customer 1 from forgetting about subsequent purchases.

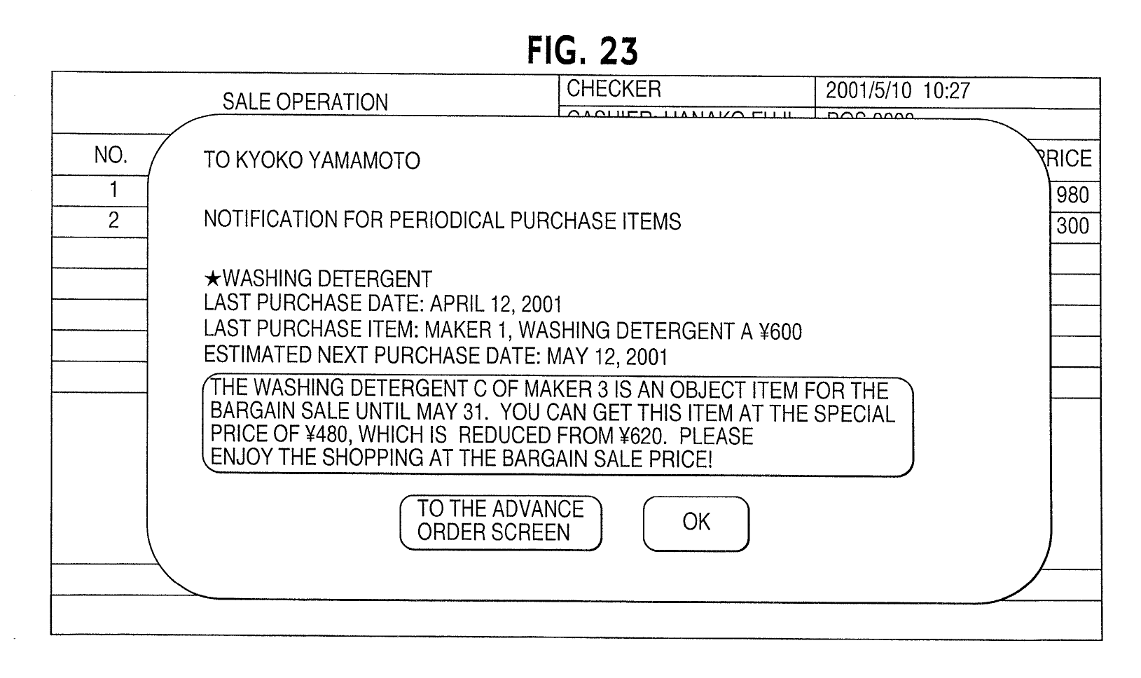

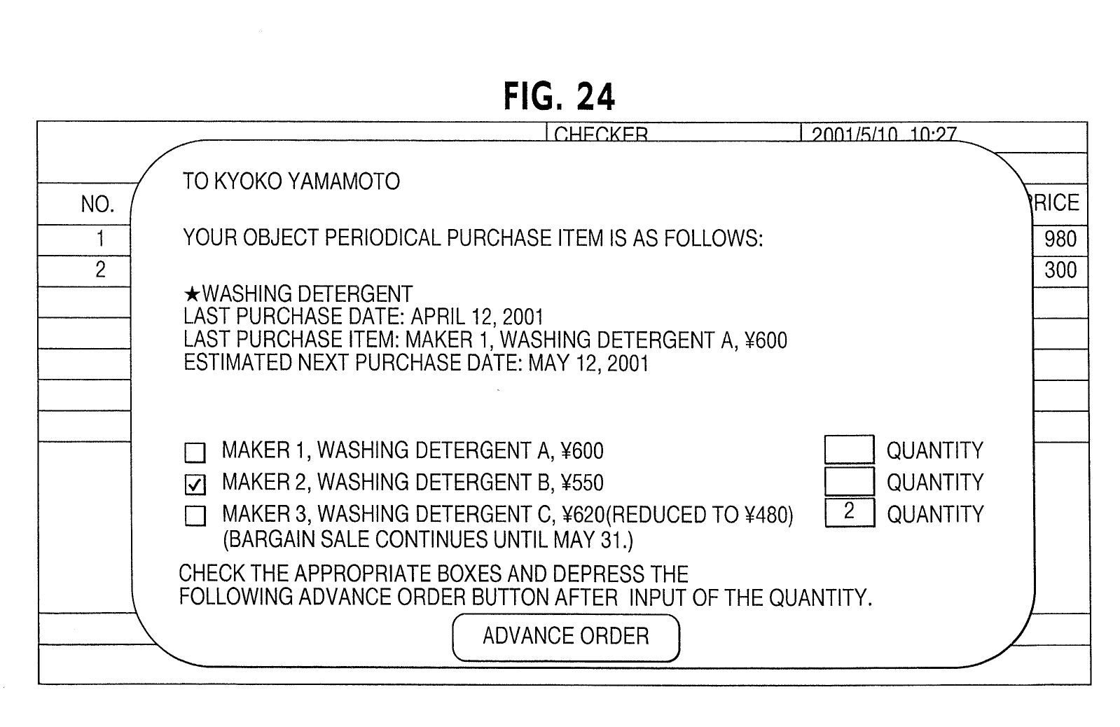

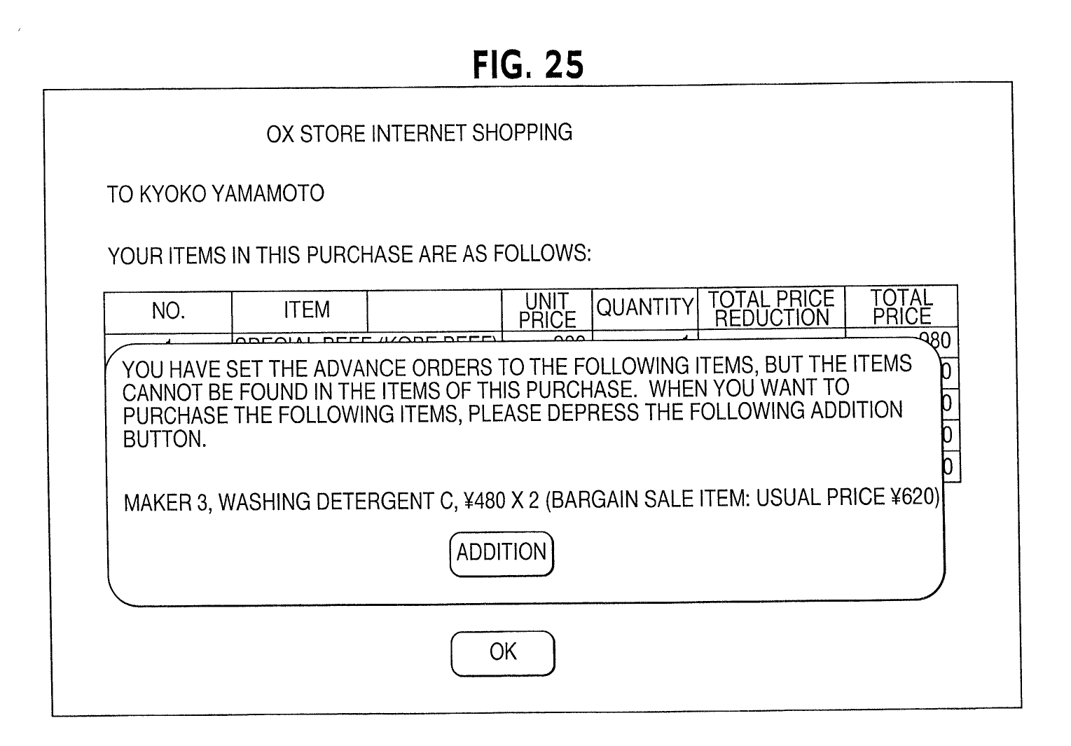

The embodiments described above illustrate examples where notification to a customer 1 and advance ordering by a customer 1 are executed at the customer terminal 105 and customer transactions are executed at the POS terminal 300. However, it is also possible to conduct customer notification, advance ordering by a customer, and customer transactions at the POS terminal 300. An example of the display screen for customer notification on the POS display screen 206 is shown in FIG. 23, while an example of the customer advance order display screen on the POS display screen 206 is shown in FIG. 24. Further, for purchases involving, for example, Internet shopping, which is spreading widely, such information exchange with customers can be realized on the web browsers of customer terminals 105. An example of an advance order information display for the Internet shopping system is shown in FIG. 25.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A store information processor, comprising:
a transaction management unit receiving and managing transaction information of a customer;
a purchase record management unit generating a purchase record from the transaction information of the customer;
an estimation unit estimating the next purchase date of an item class from a purchase frequency of the item class calculated from the purchase record; and
a notification unit notifying the customer of the estimated next purchase date.

2. A store information processor according to claim 1, wherein the notification unit sends an electronic mail message to the customer as the notification.

3. A store information processor according to claim 1, further comprising an advance order unit presenting information about a group of items belonging to the item class to the customer, and receiving and managing information about advance order items to be purchased, which are selected by the customer from the group of items.

4. A store information processor according to claim 2, wherein the advance order unit sends sales promotion information for the group of items belonging to the item class.

5. A store information processor according to claim 1, wherein the notification unit notifies the customer of the estimated next purchase date of an item class designated by the customer before the estimated next purchase date.

6. A store information processor according to claim 1, wherein the notification unit notifies the customer of the estimated next purchase date of an item class determined by a store before the estimated next purchase date.

7. A store information processing method, comprising:
receiving and managing transaction information of a customer;
generating a purchase record from the transaction information of the customer;
estimating the next purchase date of an item class from a purchase frequency of the item class calculated from the purchase record; and
notifying the customer of the estimated new purchase date.

8. A store information processing method according to claim 7, wherein the notification is executed using an electronic mail message on the Internet network.

9. A store information processing method according to claim 7, further comprising presenting, to the customer, information about a group of items belonging to the item class and receiving, for management, information about advance order items to be purchased, which are selected by the customer from the group of items.

10. A store information processing method according to claim 7, further comprising notifying the customer of the estimated new purchase date of an item class designated by the customer before the estimated next purchase date.

11. A store information processing method according to claim 7, further comprising notifying the customer of the estimated next purchase date of an item class determined by a store before the estimated next purchase date.

12. A store information processing system, comprising:
at least one terminal connected to a communication network; and
a store information processor comprising:
a communication unit connecting the store information processor to the communication network,
a transaction management unit receiving customer transaction information at the at least one terminal,
a purchase record management unit generating a purchase record from the customer transaction information,
an estimation unit estimating the next purchase ate of an item class from a purchase frequency of the item class, calculated from the purchase record, and
a notification unit notifying the customer of the estimated new purchase date via the at least one terminal connected to the communication network when the next purchase date nears.

13. A terminal, comprising a display screen receiving, when customer transaction information is processed, information to place an advance order of an item, and displaying the information on the display screen.

14. A terminal, comprising:
an advance order information receiving unit receiving information to place an advance order of an item to be purchased by a customer during a transaction process managed by a store information processor at the time of processing of the transaction; and
an advance order information display unit displaying the information about the advance order on a display screen of the display unit.

15. A terminal, comprising:
a purchase information receiving unit receiving, at the time of a customer transaction, information to prompt a customer to purchase an item as an estimated purchase date of a class of an item nears, the customer transaction being managed by a store information processor; and
a purchase information display unit displaying the information on a display screen of the display unit.
